(19) United States
(12) Patent Application Publication
(10) Pub. No.: US 2019/0072393 A1
(43) Pub. Date: Mar. 7, 2019

(54) USING RSU IN DSRC SYSTEM AS A LOCAL BASE STATION IN GPS RTK MODULE

(71) Applicant: Panasonic Automotive Systems Company of America, Division of Panasonic Corporation of North America, Peachtree City, GA (US)

(72) Inventors: SAMEH WILLIAM TAWADROUS, SENOIA, GA (US); HANS A. TROEMEL, JR., SHARPSBURG, GA (US)

(73) Assignee: Panasonic Automotive Systems Company of America, Division of Panasonic Corporation of North America

(21) Appl. No.: 16/122,086

(22) Filed: Sep. 5, 2018

Related U.S. Application Data
(60) Provisional application No. 62/554,116, filed on Sep. 5, 2017.

(51) Int. Cl. G01C 21/20; G08G 1/0967; G01S 19/43; G01S 19/48

(52) U.S. Cl. CPC G01C 21/20; G01S 19/48; G01S 19/43; G08G 1/096783

(57) ABSTRACT

On board equipment in a motor vehicle includes a DSRC radio receiving a calculated GPS position error from road side equipment. The calculated GPS position error is based upon a difference between a known position of the road side equipment and a position estimated by a first GPS receiver within the road side equipment. A second GPS receiver is communicatively coupled to the DSRC radio and estimates a position of the vehicle. The second GPS receiver adjusts the estimation of the vehicle position based upon the calculated GPS position error.

### CROSS-REFERENCE TO RELATED APPLICATION

This application claims benefit of U.S. Provisional Application No. 62/554,116 filed on Sep. 5, 2017, which the disclosure of which is hereby incorporated by reference in its entirety for all purposes.

### FIELD OF THE INVENTION

The disclosure relates to determining the global position coordinates of a motor vehicle.

### BACKGROUND OF THE INVENTION

An on board unit (OBU) is the part of the dedicated short range communications (DSRC) system that is installed in the moving vehicle. The on board equipment (OBE) contains other equipment in addition to the OBU, such as a human machine interface unit and other communication equipment for the car. The road side unit (RSU) is the part of the DSRC system that is installed on the side of the road. The road side equipment (RSE) contains the RSU in addition to other equipment to link the RSU to the backend network that may be hosted in the cloud.

The DSRC implementation of RSU standard does not require precise GPS time in order to function properly.

### SUMMARY

The present invention may use RSE as a local base station in a Real Time Kinematic (RTK) module in a DSRC system. After the GPS receiver in the RSE is able to get a fix, the fix information can be used as input to an RTK engine along the pre-known location of the RSE to calculate certain GPS system errors such as orbital inaccuracies and ionic sphere modeling. The RSU in turn may send output parameters from the RTK module over the DSRC channel to the OBU and then to the GPS receiver in the OBE. With the RTK errors or correction model delivered to the GPS receiver in the OBE, the GPS receiver may be able to achieve a lane-accurate position fix.

In one embodiment, the invention comprises on board equipment in a motor vehicle, including a DSRC radio receiving a calculated GPS position error from road side equipment. The calculated GPS position error is based upon a difference between a known position of the road side equipment and a position estimated by a first GPS receiver within the road side equipment. A second GPS receiver is communicatively coupled to the DSRC radio and estimates a position of the vehicle. The second GPS receiver adjusts the estimation of the vehicle position based upon the calculated GPS position errors and/or correction model done in the RSE.

In another embodiment, the invention comprises a global positioning method for a motor vehicle, including the following steps performed within the motor vehicle. A calculated GPS position errors and/or correction model is received from road side equipment. The calculated GPS position error is based upon a difference between a known position of the road side equipment and a position estimated by a first GPS receiver within the road side equipment. A global position of the motor vehicle is estimated. The estimation of the vehicle's global position is adjusted based upon the calculated GPS position error and/or correction model. The adjusted estimation of the vehicle's global position may be accurate within less than one meter.

In yet another embodiment, the invention comprises a global positioning arrangement for a motor vehicle. The arrangement includes on board equipment disposed within the motor vehicle and road side equipment. The road side equipment includes a first GPS receiver estimating a global position of the road side equipment. A module is communicatively coupled to the first GPS receiver and calculates a GPS position error based upon a difference between a known global position of the road side equipment and the global position of the road side equipment as estimated by the first GPS receiver. A first radio receives the calculated GPS position error from the module and wirelessly transmits the calculated GPS position error and or correction model. The on board equipment includes a second radio receiving the calculated GPS position error from the first radio. A second GPS receiver is communicatively coupled to the second radio and estimates a position of the vehicle. The on board equipment adjusts the estimation of the vehicle position based upon the calculated GPS position error or the correction model.

In a further embodiment, the invention comprises a global positioning arrangement for a motor vehicle. The arrangement includes road side equipment having a first GPS receiver estimating a position of the road side equipment. A module is communicatively coupled to the first GPS receiver and calculates a GPS position error based upon a difference between a known position of the road side equipment and the position of the road side equipment as estimated by the first GPS receiver. The module models at least one factor that caused the GPS position error. A first radio receives the at least one factor model from the module and wirelessly transmits the at least one factor model. On board equipment is disposed within the motor vehicle. The on board equipment includes a second radio receiving the at least one factor model from the first radio. A second GPS receiver is communicatively coupled to the second radio and estimates a position of the vehicle dependent upon the at least one factor model.

An advantage of the present invention is that it may, in OBE, reduce GPS position error from meters to lane-accurate (e.g., centimeters). This is very important for robust implementation of many safety apps in the connected industry.

### BRIEF DESCRIPTION OF THE DRAWINGS

A better understanding of the present invention will be had upon reference to the following description in conjunction with the accompanying drawings.

FIG. 1 is a block diagram of one example embodiment of a global positioning arrangement of the present invention for a motor vehicle.

FIG. 2 is a flow chart of one embodiment of a global positioning method of the present invention for a motor vehicle.

### DETAILED DESCRIPTION OF THE PREFERRED EMBODIMENTS

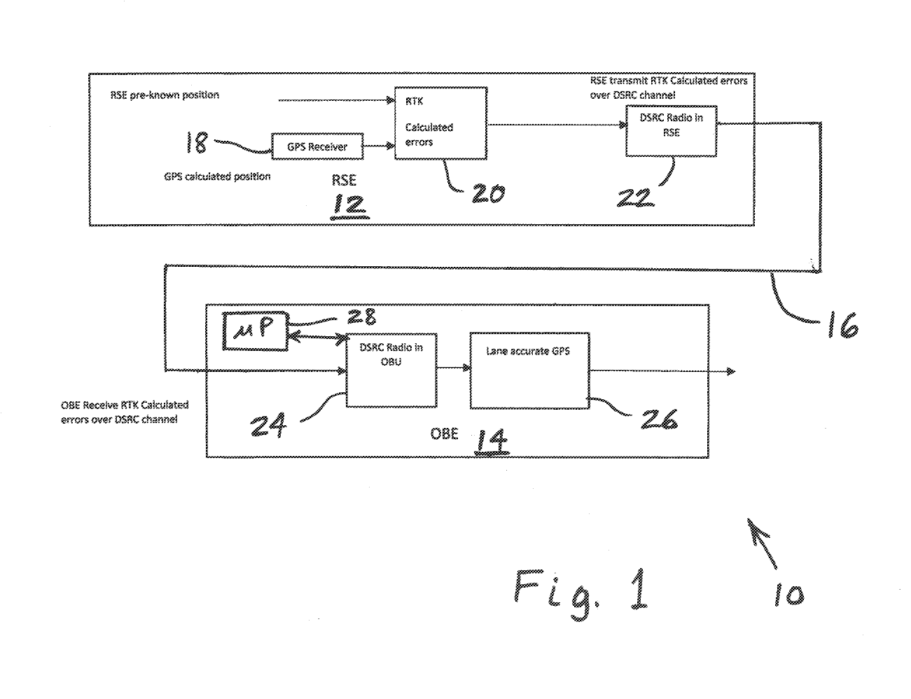

FIG. 1 illustrates one example embodiment of a global positioning arrangement 10 of the present invention for a motor vehicle. Arrangement 10 includes RSE 12 and OBE 14 communicatively coupled via DSRC channel 16. RSE 12 includes a GPS receiver 18, an RTK module 20, and a DSRC radio 22. OBE 14 includes a DSRC radio 24, a GPS receiver 26 and an electronic processor 28.

During use, RSE 12 has a pre-known position which was determined when RSE 12 was permanently and fixedly installed. This pre-known position may be communicated to RTK module 20. GPS receiver 18 may calculate a position and communicate this calculated position to RTK module 20. RTK module 20 may then calculate a GPS position error based on a difference between the GPS calculated position and the pre-known position of the RSE. RTK module 20 then may transmit the calculated GPS position error to DSRC radio 22. Next, DSRC radio 22 of RSE 12 may transmit the RTK calculated GPS position error over DSRC channel 16.

DSCR radio 24 of the OBU and OBE 14 may receive the RTK calculated GPS position error over DSRC channel 16. GPS receiver 26 may receive and use the RTK calculated GPS position error to correct and/or adjust its own calculated global position coordinates such that its adjusted global position coordinates are accurate to within less than one meter and thus the lane that the vehicle having ORE 14 is in can be reliably determined. More particularly, the error calculated between the calculated position of RSE 12 and the actual position of RSE 12 might not he used directly to correct the position calculation of OBE 14. Rather, the error calculated between the calculated position of RSE 12 and the actual position of RSE 12 may be used to model factors that caused the error, such as satellite orbital inaccuracies, local ionic sphere and perhaps other factors. Then these factor models may be used in, and applied to, the position calculation of OBE 14. The modeling of the errors may be performed in RSE 12 or in OBE 14.

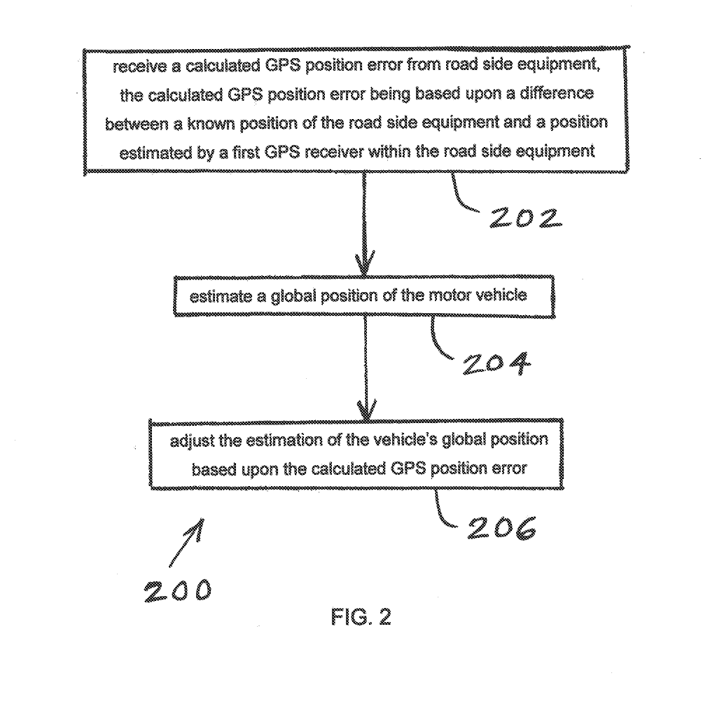

FIG. 2 illustrates one embodiment of a global positioning method 200 of the present invention for a motor vehicle. In a first step 202, a calculated GPS position error is received from road side equipment. The calculated GPS position error is based upon a difference between a known position of the road side equipment and a position estimated by a first GPS receiver within the road side equipment. For example, RTK module 20 may calculate a GPS position error based on a difference between the GPS calculated position and a pre-known position of the RSE. RTK module 20 then may transmit the calculated GPS position error to DSRC radio 22. Next, DSRC radio 22 of RSE 12 may transmit the RTK calculated GPS position error over DSRC channel 16 to OBE 14.

Next, in step 204, a global position of the motor vehicle is estimated. For example, GPS receiver 26 may calculate its own calculated global position coordinates.

In a final step 206, the estimation of the vehicle's global position is adjusted based upon the calculated GPS position error. For example, GPS receiver 26 may receive and use the RTK calculated GPS position error to correct and/or adjust its own calculated global position coordinates.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed:

1. On board equipment in a motor vehicle, the on board equipment comprising:
a DSRC radio configured to receive a calculated GPS position error from road side equipment, the calculated GPS position error being based upon a difference between a known position of the road side equipment and a position estimated by a first GPS receiver within the road side equipment; and
a second GPS receiver communicatively coupled to the DSRC radio and configured to:
estimate a position of the vehicle; and
adjust the estimation of the vehicle position based upon the calculated GPS position error or a correction model generated based upon the calculated GPS position error.

2. The arrangement of claim 1 wherein the DSRC radio is configured to receive the calculated GPS position error over a DSRC channel.

3. The arrangement of claim 1 wherein the DSRC radio is disposed within an on board unit within the on board equipment.

4. The arrangement of claim 1 wherein the DSRC radio comprises a second DSRC radio and is configured to receive the calculated GPS position error or the correction model from a first DSRC radio of the road side equipment.

5. The arrangement of claim 1 wherein the second GPS receiver is configured to provide the adjusted estimation of the vehicle position to another application within the motor vehicle.

6. The arrangement of claim 1 further comprising an electronic processor communicatively coupled to the second GPS receiver and configured to determine, based upon the adjusted estimation of the vehicle position, a traffic lane in which the motor vehicle is traveling.

7. The arrangement of claim 1 wherein the adjusted estimation of the vehicle position is accurate to within less than one meter.

8. A global positioning method for a motor vehicle, the method comprising the following steps performed within the motor vehicle:
receiving a calculated GPS position error or correction model from road side equipment or a module communicatively coupled to the road side equipment, the calculated GPS position error being based upon a difference between a known position of the road side equipment and a position estimated by a first GPS receiver within the road. side equipment;
estimating a global position of the motor vehicle; and
adjusting the estimation of the vehicle's global position based upon the calculated GPS position error or the correction model generated in the road side equipment or a module communicatively coupled to the road side equipment.

9. The method of claim 8 wherein the calculated GPS position error is received over a DSRC channel.

10. The method of claim 8 wherein the calculated GPS position error or the correction model is received by a DSRC radio disposed within an on board unit within on board equipment in the motor vehicle.

11. The method of claim 10 wherein the DSRC radio comprises a second DSRC radio and receives the calculated GPS position error and/or the correction model from a first DSRC radio within road side equipment.

12. The method of claim 8 wherein the adjusted estimation of the vehicle's global position is used by a computer application within the motor vehicle.

13. The method of claim 8 further comprising determining, based upon the adjusted estimation of the vehicle position, a traffic lane in which the motor vehicle is traveling.

14. The method of claim 8 wherein the adjusted estimation of the vehicle position is accurate to within less than one meter.

15. A global positioning arrangement for a motor vehicle, the arrangement comprising:
road side equipment including:
a first GPS receiver configured to estimate a position of the road side equipment;
a module communicatively coupled to the first GPS receiver and configured to calculate a GPS position error based upon a difference between a known position of the road side equipment and the position of the road side equipment as estimated by the first GPS receiver; and
a first radio configured to receive the calculated GPS position error and/or a correction model from the module and wirelessly transmit the calculated GPS position error;
on board equipment disposed within the motor vehicle, the on board equipment including:
a second radio configured to receive the calculated GPS position error or the correction model from the first radio; and
a second GPS receiver communicatively coupled to the second radio and configured to:
estimate a position of the vehicle; and
adjust the estimation of the vehicle position based upon the calculated GPS position error.

16. The arrangement of claim 15 wherein the module comprises a Real Time Kinematic (RTK) module.

17. The arrangement of claim 15 wherein the first radio comprises a first DSRC radio and the second radio comprises a second DSRC radio.

18. The arrangement of claim 17 wherein the second DSRC radio is configured to receive the calculated GPS position error from the first DSRC radio over a DSRC channel.

19. The arrangement of claim 15 further comprising an electronic processor disposed within the motor vehicle and communicatively coupled to the second GPS receiver and configured to determine, based upon the adjusted estimation of the vehicle position, a traffic lane in which the motor vehicle is traveling.

20. The arrangement of claim 15 wherein the adjusted estimation of the vehicle position is accurate to within less than one meter.

21. A global positioning arrangement for a motor vehicle, the arrangement comprising:
road side equipment including:
a first GPS receiver configured to estimate a position of the road side equipment;
a module communicatively coupled to the first GPS receiver and configured to:
calculate a GPS position error based upon a difference between a known position of the road side equipment and the position of the road side equipment as estimated by the first GPS receiver; and
model at least one factor that caused the GPS position error; and
a first radio configured to receive the at least one factor model from the module and wirelessly transmit the at least one factor model;
on board equipment disposed within the motor vehicle, the on board equipment including:
a second radio configured to receive the at least one factor model from the first radio; and
a second GPS receiver communicatively coupled to the second radio and configured to estimate a position of the vehicle dependent upon the at least one factor model.

22. The arrangement of claim 21 wherein the module comprises a Real Time Kinematic (RTK) module.

23. The arrangement of claim 21 wherein the first radio comprises a first DSRC radio and the second radio comprises a second DSRC radio.

24. The arrangement of claim 23 wherein the second DSRC radio is configured to receive the at least one factor model from the first DSRC radio over a DSRC channel.

25. The arrangement of claim 21 further comprising an electronic processor disposed within the motor vehicle and communicatively coupled to the second GPS receiver and configured to determine, based upon the estimated vehicle position, a traffic lane in which the motor vehicle is traveling.

26. The arrangement of claim 21 wherein the estimation of the vehicle position is accurate to within less than one meter.

27. The arrangement of claim 21 wherein the at least one factor includes satellite orbital inaccuracies and/or local ionic sphere.
